(19) United States
(12) Patent Application Publication
(10) Pub. No.: US 2005/0092944 A1
(43) Pub. Date: May 5, 2005

(54) Throttle valve apparatus for controlling fluid flow

(76) Inventor: Mark A. Patterson, Plano, TX (US)

Correspondence Address: SLATER & MATSIL, L.L.P., 17950 PRESTON RD, SUITE 1000, DALLAS, TX, 75252-5793, US

(21) Appl. No.: 10/770,802

(22) Filed: Feb. 3, 2004

Related U.S. Application Data
(60) Provisional application No. 60/444,857, filed on Feb. 4, 2003.

(51) Int. Cl. F16K 7/04

(52) U.S. Cl. 251/4

(57) ABSTRACT

A throttle valve apparatus for controlling fluid flow is provided, which includes a first hollow body portion, a second hollow body portion, and an internal duct. The first hollow body portion, second hollow body portion, and the internal duct, each extends along a longitudinal axis of the apparatus. The duct is formed from a pliable membrane. The duct is attached to the first body portion at a first duct location. The duct is also attached to the second body portion at a second duct location. The first body portion and the first duct location are adapted to pivot about the longitudinal axis relative to the second body portion and the second duct location for twisting and untwisting the duct. Preferably, yet optionally, rods are in contact with the duct and extend generally along the longitudinal axis for supporting the duct.

### CROSS-REFERENCE TO RELATED APPLICATION

This application claims the priority benefit of commonly owned U.S. Provisional Patent Application having Ser. No. 60/444,857 entitled THROTTLE VALVE APPARATUS FOR CONTROLLING FLUID FLOW filed on Feb. 4, 2003, which is hereby incorporated by reference.

The present application is related to a U.S. patent application by the same inventor having Ser. No. 10/238,254 entitled THROTTLE VALVE APPARATUS FOR CONTROLLING FLUID FLOW filed on Sep. 10, 2002, and which is hereby incorporated by reference.

### TECHNICAL FIELD

The present invention relates to throttle valves for controlling fluid flow. More specifically, it relates to a throttle valve apparatus for controlling fluid flow using a pliable duct.

### BACKGROUND

A conventional throttle valve apparatus used on a vehicle engine system, for example, typically incorporates a butterfly valve with a single throttle blade that pivots about a single axis extending across the center of the throttle blade. FIGS. 1-4 show an example of a conventional throttle valve apparatus 10 having a single throttle blade 11. FIG. 1 shows a perspective view of a conventional throttle valve apparatus 10 incorporating a single throttle blade 11. FIG. 2 shows a sectional side view of the throttle valve apparatus 10 of FIG. 1 with the blade 11 in a closed position. FIGS. 3 and 4 show the throttle blade 11 of FIG. 2 in half-open and full-open positions, respectively. When a conventional throttle blade 11 is only partially opened (i.e., between fully closed and fully open), as shown in FIG. 3 for example, the throttle blade 11 causes a high pressure on one side of the blade and a low pressure on the other side. Such pressure difference causes turbulence. Also when a conventional throttle blade 11 is only partially opened, more air flows to one side of the throttle valve apparatus 10 than to the other side. This restricts the volumetric flow rate through the throttle body 12. Hence, there is a need for an improved throttle valve design that addresses these issues.

### SUMMARY OF THE INVENTION

The problems and needs outlined above may be addressed by embodiments of the present invention. In accordance with one aspect of the present invention, an apparatus for controlling fluid flow is provided, which includes a first hollow body portion, a second hollow body portion, and an internal duct. The first hollow body portion, second hollow body portion, and the internal duct, each extends along a longitudinal axis of the apparatus. The duct is formed from a pliable membrane. The duct is attached to the first body portion at a first duct location. The duct is also attached to the second body portion at a second duct location. The first body portion and the first duct location are adapted to pivot about the longitudinal axis relative to the second body portion and the second duct location for twisting and untwisting the duct.

In accordance with another aspect of the present invention, an apparatus for controlling fluid flow, which includes a first hollow body portion, a second hollow body portion, an internal duct, and a rod. The first hollow body portion, second hollow body portion, and the internal duct, each extends along a longitudinal axis of the apparatus. The duct is formed from a pliable membrane. The duct is attached to the first body portion at a first duct location. The duct is also attached to the second body portion at a second duct location. The first body portion and the first duct location are adapted to pivot about the longitudinal axis relative to the second body portion and the second duct location for twisting and untwisting the duct. The rod is in contact with the duct and extending generally along the longitudinal axis to support the duct.

In accordance with yet another aspect of the present invention, an apparatus for controlling fluid flow, which includes a first hollow body portion, a second hollow body portion, and an internal duct. The first hollow body portion, second hollow body portion, and the internal duct, each extends along a longitudinal axis of the apparatus. The second body portion is adjacent to the first body portion along the longitudinal axis. The duct is formed from a pliable membrane. At least part of the duct is located in at least part of the first and second body portions. The duct has a first duct end attached to the first body portion. The duct has a second duct end attached to the second body portion. The first body portion and the first duct end are adapted to pivot about the longitudinal axis relative to the second body portion and the second duct end for twisting and untwisting the duct.

In accordance with still another aspect of the present invention, a method of controlling fluid flow is provided. This method includes the following steps described in this paragraph, and the order of steps may vary. An apparatus is provided, which includes a first hollow body portion, a second hollow body portion, and an internal duct. The first hollow body portion, second hollow body portion, and internal duct, each extends along a longitudinal axis of the apparatus. The duct is formed from a pliable membrane. The duct is attached to the first body portion at a first duct location, and the duct is attached to the second body portion at a second duct location. Fluid flows at a first flow rate through the apparatus via the duct when the duct is untwisted. Fluid flow is restricted through the duct to a second flow rate when the duct is at least partially twisted, and the second flow rate is less than the first flow rate. This method requires that an apparatus be “provided.” This term “provided” (or “providing” in the claim(s)) includes having the apparatus ready for use in subsequent steps, even though the apparatus may have been made by another prior to engaging in the method, as well as making, fabricating, assembling, and/or partially assembling the apparatus and having it for use in subsequent steps, for example.

The foregoing has outlined rather broadly features of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

The following is a brief description of the drawings, which illustrate exemplary embodiments of the present invention and in which:

FIG. 1 is perspective view of a conventional single blade throttle body;

FIG. 2 is a sectional side view of the throttle body of FIG. 1 in a closed position;

FIG. 3 is a sectional side view of the throttle body of FIG. 1 in a half-open position;

FIG. 4 is a sectional side view of the throttle body of FIG. 1 in a full-open position;

FIGS. 5-11 show various views and configurations of a first embodiment of the present invention;

FIG. 12 is a sectional side view showing a second embodiment of the present invention;

FIG. 13 is a sectional side view showing a third embodiment of the present invention;

FIG. 14 is a perspective view showing a duct of a fourth embodiment of the present invention;

FIG. 15 is a perspective view showing a duct of a fifth embodiment of the present invention;

FIG. 16 is an end view showing a duct of a sixth embodiment of the present invention;

FIG. 17 is an end view showing a duct of a seventh embodiment of the present invention;

FIG. 18 is an end view showing a duct of an eighth embodiment of the present invention;

FIG. 19 is a perspective view showing a duct of a ninth embodiment of the present invention;

FIGS. 20A-20L are various cross-sections of duct rods that may be incorporated into an embodiment of the present invention;

FIG. 21 is a sectional view showing a portion of an intake port having a conventional throttle blade therein;

FIG. 22 is a sectional view showing the intake port of FIG. 21 incorporating an embodiment of the present invention;

FIG. 23 is a sectional view showing a portion of an engine head incorporating an embodiment of the present invention;

FIG. 24 is a sectional view showing a portion of an engine head and an intake port having a conventional throttle blade therein;

FIG. 25 is a sectional view showing the engine head and intake port of FIG. 24 incorporating an embodiment of the present invention;

FIGS. 26 and 27 are sectional views showing other embodiments of the present invention;

FIGS. 28 and 29 are side views, with portions broken away for illustration, showing tenth and eleventh embodiments of the present invention, respectively, where the duct is pliable but having little or no ability to be stretched;

FIG. 30 is a sectional side view showing a twelfth embodiment of the present invention; and

FIG. 31 is a plot showing a performance comparison between a conventional throttle body and a throttle body in accordance with the first embodiment incorporating the duct of FIG. 14.

### DETAILED DESCRIPTION OF ILLUSTRATIVE EMBODIMENTS

Referring now to the drawings, wherein like reference numbers are used herein to designate like or similar elements throughout the various views, illustrative embodiments of the present invention are shown and described. The figures are not necessarily drawn to scale, and in some instances the drawings have been exaggerated and/or simplified in places for illustrative purposes only. One of ordinary skill in the art will appreciate the many possible applications and variations of the present invention based on the following illustrative embodiments of the present invention. The illustrative embodiments discussed herein are just some illustrative examples of the present invention and do not limit the scope of the invention to the illustrative embodiments described.

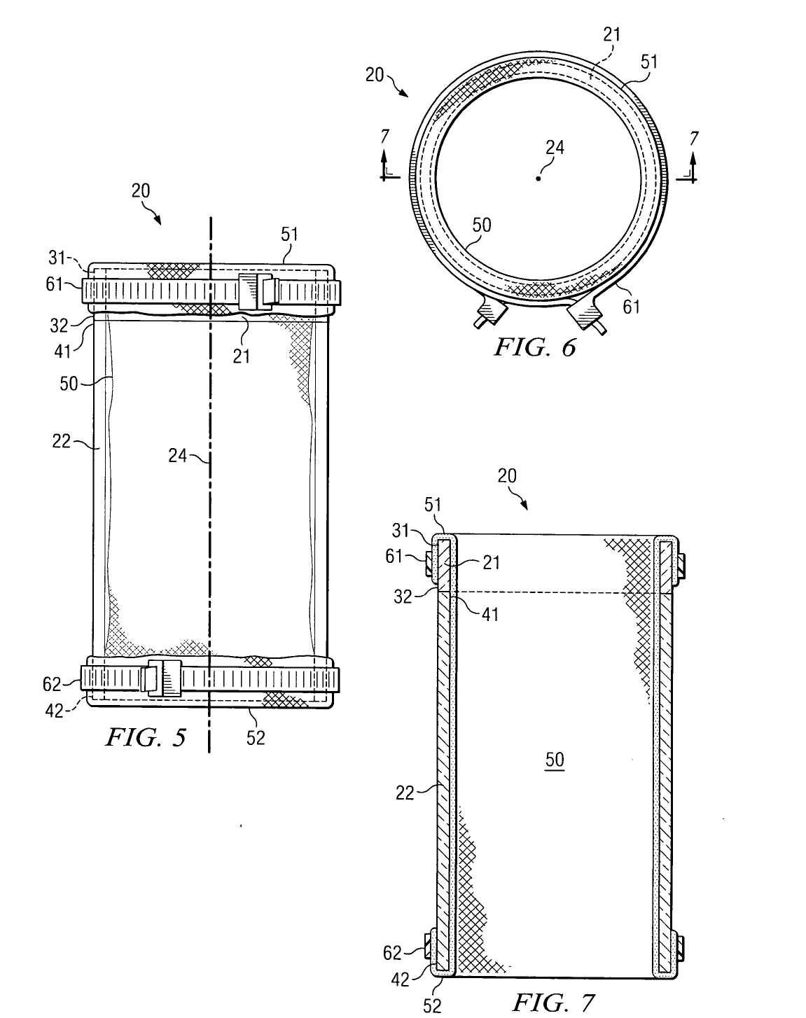

FIGS. 5-11 show a throttle valve apparatus 20 in accordance with a first embodiment of the present invention. The first embodiment 20 shown herein (i.e., FIGS. 5-11) is a prototype for illustration purposes. FIG. 5 is a side view of the throttle valve apparatus 20. The throttle valve apparatus 20 has a first body portion 21 that extends along a longitudinal axis 24 of the apparatus 20. The first body portion 21 is hollow and cylindrical shaped in this embodiment. The first body portion 21 has a first end 31 and a second end 32. A second body portion 22 also extends along the longitudinal axis 24 adjacent to the first body portion 21. The second body portion 22 is also hollow and cylindrical shaped in this embodiment. The second body portion 22 has a first end 41 and a second end 42. The second end 32 of the first body portion 21 is adjacent to the first end 41 of the second body portion 22.

An internal duct 50 extends along the longitudinal axis 24 within the first and second body portions 21, 22. The internal duct 50 is formed from a pliable and stretchable membrane. The duct 50 has a first duct end 51 and a second duct end 52. The first duct end 51 is wrapped around the first end 31 of the first body portion 21 and attached thereto. The first duct end 51 is attached to the first end 31 of the first body portion 21 by a first zip tie 61, which clamps onto the first duct end 51 and about the first body portion 21. The second duct end 52 is wrapped around the second end 42 of the second body portion 22 and attached thereto. Like the first duct end 51, the second duct end 52 is clamped onto the second body portion 22 by a second zip tie 62. In this prototype, the second body portion 22 is made from clear acrylic material to better illustrate the twisting and untwisting of the internal duct 50 therein.

FIG. 6 is an end view of the apparatus 20 of FIG. 5 looking along the longitudinal axis 24. FIG. 7 is a sectional view of the apparatus 20 as taken along line 7-7. In FIGS. 5-7, the duct 50 is in a fully-open position, i.e., the duct 50 is untwisted about the longitudinal axis 24.

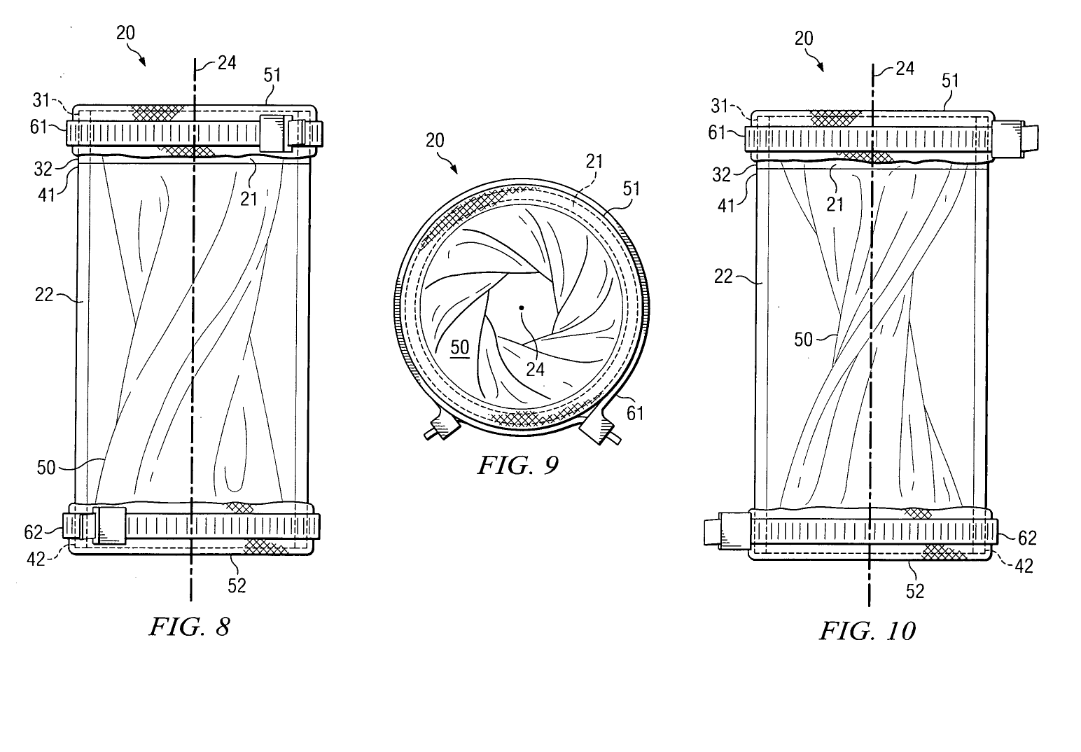

The flow of fluid through the apparatus 20 may be controlled by altering the shape of the duct 50, as will be described next. The first body portion 21 is adapted to pivot relative to the second body portion 22 about the longitudinal axis 24. Because the first duct end 51 is attached to the first body portion 21 and the second duct end 52 is attached to the second body portion 22, when the first body portion 21 is pivoted about the longitudinal axis 24 relative to the second body portion 22, the flexible duct 50 is twisted. As illustrated in FIGS. 8-11, the amount of twisting of the duct 50 (i.e., amount of pivoting of the first body portion 21 relative to the second body portion 22) corresponds to the amount of fluid flow allowed to pass through the duct 50.

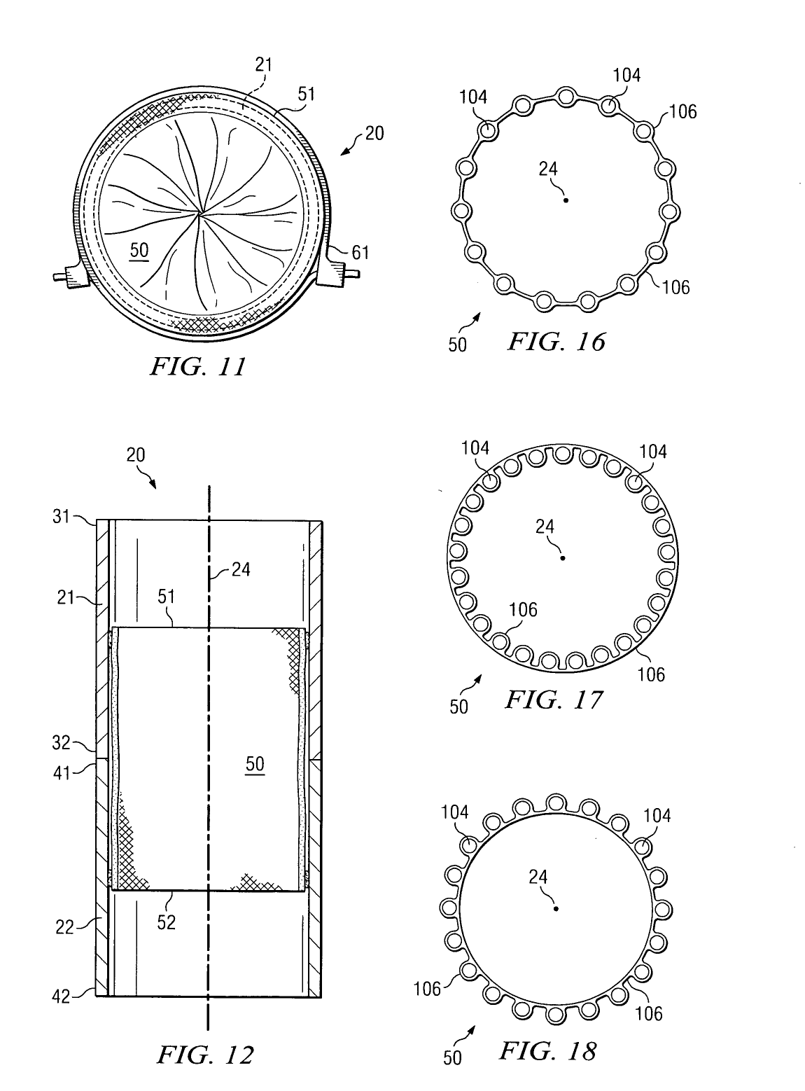

In FIGS. 8 and 9, the throttle valve apparatus 20 is in a half-open (or half-closed) configuration. That is, the duct 50 is partially twisted, thereby reducing the duct opening size near the middle of the duct 50. In FIGS. 10 and 11, the throttle valve apparatus 20 is in a fully-closed configuration. That is, in FIGS. 10 and 11 the duct 50 is twisted more than it is in FIGS. 8 and 9. The middle of the duct 50 is twisted to a smaller configuration to effectively close the duct 50 at the middle.

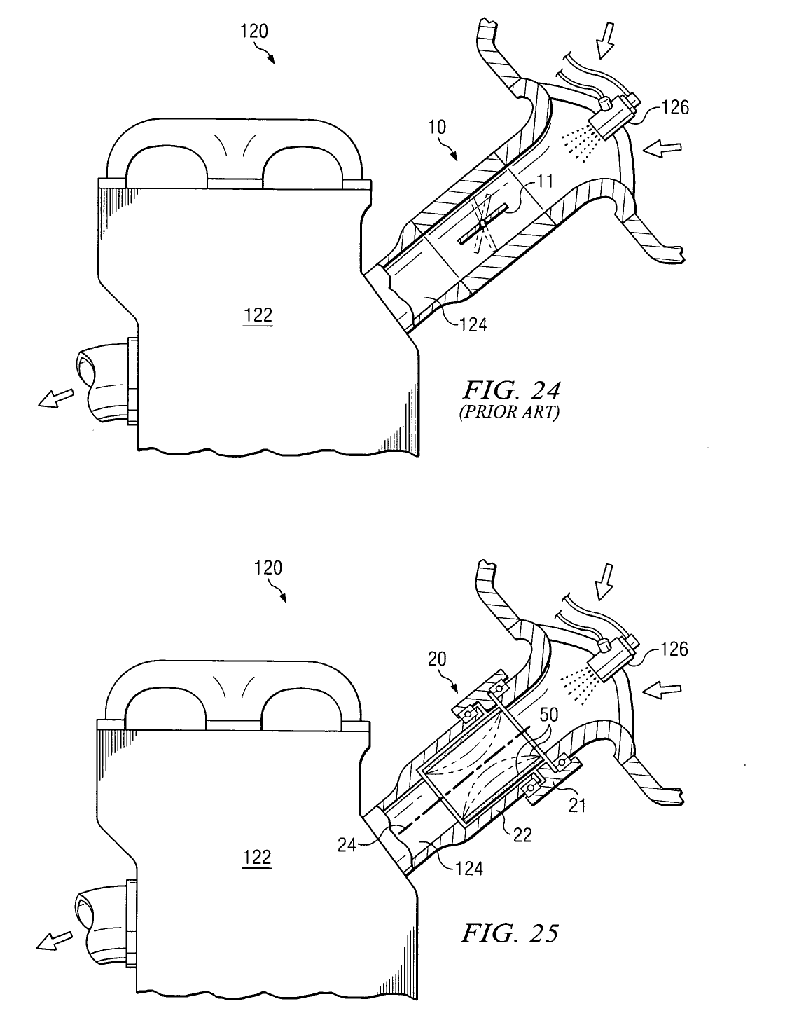

One of the advantages of a throttle valve embodiment of the present invention is that the opening size for the middle of the duct may be continuously varied with any size of pivotal increments. Another advantage of a throttle valve embodiment of the present invention is that the restricting opening for the valve at all positions is near the center of the duct. Having the fluid flow concentrated toward the center of the duct at most or all throttle valve positions may be beneficial for a number of reasons. Keeping the flow concentrated toward the center of the duct along the longitudinal axis at all throttle positions is likely to be much better than forcing the flow to one side, as a conventional single blade design does (see e.g., FIG. 3). For example, if an injector is spraying along the longitudinal axis (see e.g., FIGS. 25-27, described below), then the fuel will always or most of the time be released directly into the air flow through the duct. Still another advantage of an embodiment of the present invention is that the duct is generally conically shaped on each side when twisted to provide an aerodynamically-favorable transition from the larger opening size to the smaller opening size (and vice versa). Yet another advantage of an embodiment of the present invention is that the duct often tends to form folds in a diagonal direction as it is twisted, which may provide a rifling effect on the fluid flowing therethrough. Such rifling effect may cause the fluid flowing therethrough to twist or swirl about the longitudinal axis 24, which may be desired for some applications.

Although in the first embodiment of FIGS. 5-11 the first duct end 51 is attached to the first end 31 of the first body portion 21 and the second duct end 52 is attached to the second end 42 of the second duct portion 22, other attachment points are possible in other embodiments. The ends 51, 52 of the duct 50 may be attached anywhere on the body portions 21, 22, depending on the application needs and the design choice. The duct ends 51, 52 may be attached to the inside or outside of the body portions 21, 22, for example. The duct ends 51, 52 may be attached at any location on the body portions 21, 22 along the longitudinal axis 24, as well, for example. Also, although the duct ends 51, 52 where clamped to the body portions 21, 22 in the first embodiment (see e.g., FIGS. 5-11), the duct ends 51, 52 may be attached in many other ways, including (but not limited to): adhesively bonded, sewn to the body portions, ultrasonically bonded, thermally bonded, chemically bonded, attached using screws and/or bolts, riveted, removably attached using snaps, removably attached using a hook and loop fastener system (e.g., Velcro), held in place by an expanded/contracted snap ring in a slot, clamped using a hose clamp, or any combination thereof, for example.

For example, FIG. 12 is a sectional side view of a second embodiment of the present invention. In the second embodiment, the first duct end 51 is adhesively bonded to an inside surface of the first body portion 21 at about the middle of the first body portion 21. Similarly, in the second embodiment, the second duct end 52 is adhesively bonded to the second body portion 22 at about the middle of the second body portion 22. In another embodiment (not shown), the first duct end 51 may be attached to the second end 32 of the first body portion 21, for example. In still another embodiment (not shown), the first duct end 51 may be attached across the extent of the first body portion 21 along the longitudinal axis 24, for example. The second embodiment also illustrates that the first body portion 21 may be shorter than, the same length as, or longer than the second body portion 22. Also, either or both of the body portions 21, 22 may be pivoted to twist and untwist the duct 50.

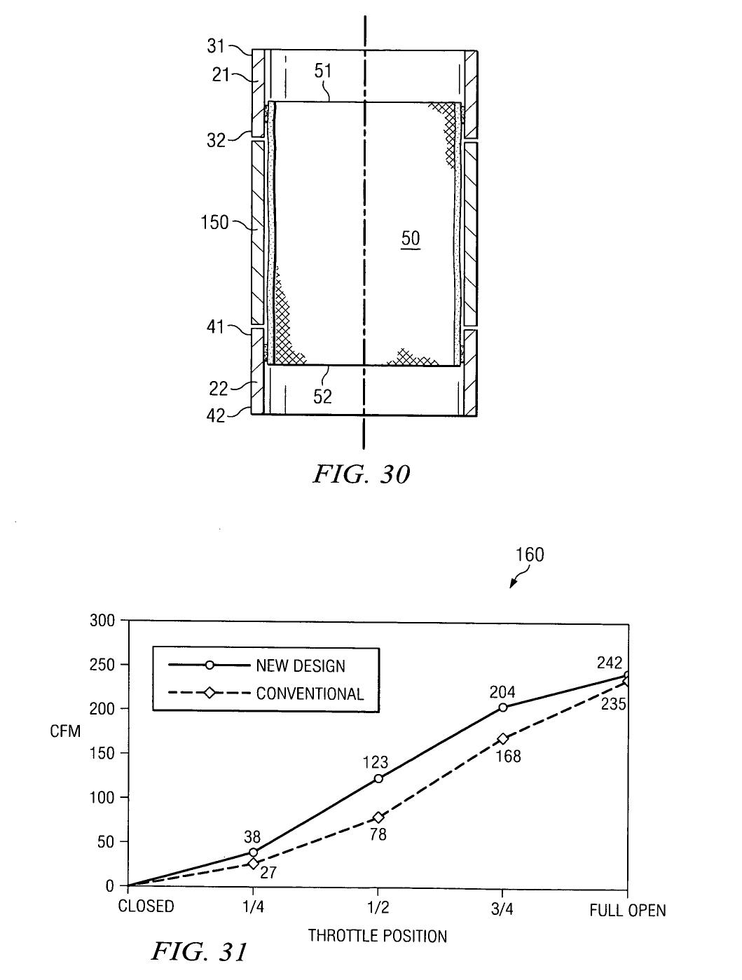

Although the first and second body portions 21, 22 are shown immediately adjacent to each other in the first and second embodiments, it is contemplated that there may be a fixed or free-floating portion located between the first and second portions 21, 22 in another embodiment (see e.g., FIG. 30 discussed below). Also, although the duct 50 is shown being attached to the inside of the first and second body portions 21, 22, it is contemplated that the duct 50 may be attached to the outside and/or end of the first and/or second body portions 21, 22. Although the duct 50 is shown being attached at the most distal locations of the duct ends 51, 52 in the first and second embodiments, in other embodiments (not shown) the duct 50 may be attached to the first body portion 21 at a first location that is not at a most distal end of the duct 50, and/or the duct 50 may be attached to the second body portion 22 at a second location that is not at a most distal end of the duct 50.

Note that the duct membrane may be made from any of a wide variety of pliable materials, which may be stretchable, flexible, partially stretchable, or non-stretchable materials. The duct membrane may be non-porous, partially non-porous, partially porous, or porous. Preferably the duct membrane is made from a substantially non-porous and stretchable material, for example. With the benefit of this disclosure, one of ordinary skill in the art may realize many different materials that may be used in an embodiment of the present invention. A few examples of duct materials include (but are not necessarily limited to): rubber, latex, woven nylon, woven cotton, woven Kevlar fibers, Lycra, Spandex, Gore-tex, or any combination thereof, for example. An example woven material for the duct membrane may include fibers having various thicknesses, so that the thicker fibers may provide greater strength in certain orientations. Also, a woven material used for the duct membrane may include fibers of different materials. For example, a duct membrane may have some relatively stiff and stronger fibers extending along the longitudinal axis of the apparatus, while other fibers of the member are more pliable and weaker. In such case, the membrane may be structured so that it is stretchable in some directions (e.g., circumferentially) and much less stretchable in other directions (e.g., longitudinally). Thus, the duct membrane may be a composite weave having anisotropic characteristics. Such anisotropic characteristics, thus, may be designed into the membrane to provide the more strength and reinforcement in certain directions. As yet another alternative, reinforcement fibers may be embedded into the duct material. For example, a duct membrane may be made from rubber having nylon fibers embedded therein and oriented along the longitudinal direction of the apparatus to provide a reinforced duct material. Such reinforcements of the duct material may be needed to prevent the membrane from collapsing under vacuum or pressurized situations. The body portions of the apparatus may be formed from any of a wide variety of materials, including (but not necessarily limited to): PVC, ABS, acrylic, nylon, thermally-molded plastic, fiberglass composite, carbon fiber composite, wood, metal, or any combination thereof, for example.

FIG. 13 is a sectional side view of a third embodiment of the present invention. The third embodiment is a motor vehicle application. The throttle valve apparatus 20 of the third embodiment may be used to control air (or an air-fuel mixture) into an internal combustion engine (not shown), for example. In the third embodiment, an electric motor 68 (e.g., servo motor with encoder, stepper motor, etc.) is pivotably coupled to a first gear 71 via a first shaft 74. The first gear 71 is engaged with a first gear portion 81 integrally formed on the outside of a first body portion 21. A throttle cable 84 is attached to a throttle pulley 86. The throttle pulley 86 is pivotably coupled to a second gear 72 via a second shaft 75. The second gear 72 engages with a second geared portion 82 integrally formed on the outside of a second body portion 22. The first body portion 21 is pivotably coupled via a first bearing 91 to a third body portion 96, which is fixed relative to the engine. The first body portion 21 is also pivotably coupled to the second body portion 22 via a second bearing 92. Hence, the first body portion 21 may pivot relative to the second and/or third body portions 22, 96. The second body portion 22 is pivotably coupled via a third bearing 93 to a fourth body portion 98, which is also fixed relative to the engine. Hence, the second body portion 22 may pivot relative to the first and/or fourth body portions 21, 98.

Still referring to FIG. 13, the throttle cable 84 may be connected to a conventional throttle pedal 100 within a driver's compartment of the vehicle (not shown). Thus, when a driver steps on the throttle pedal 100 (i.e., requesting acceleration), the second body portion 22 pivots about the longitudinal axis 24 relative to the fourth body portion 98. The electric motor 68 is communicably coupled to an engine management computer or controller 102, for example. Engine management software running on the engine management computer 102 may be programmed to provide more or less twisting/untwisting of the duct 50 in reaction to vehicle and/or engine conditions and in reaction to the driver's throttle pedal position. For example, the driver may manually actuate the pivoting of the second body portion 22 using the throttle pedal 100, and depending on the vehicle and/or engine conditions, the engine management computer 102 may prompt the electric motor 68 to actuate movement of the first body portion 21 to cancel or greatly reduce the twisting/untwisting of the duct 50. Hence, the first body portion 21 (controlled by the computer 102) may be actuated in unison with the movement of the second body portion 22 (controlled by the driver) so the duct 50 remains twisted or is untwisted less, even though the driver is pressing the throttle pedal 100, for example. Similarly, the engine management computer 102 may prompt the electric motor 68 to further twist the duct 50 (thereby further restricting air flow into the engine) in response to vehicle and/or engine conditions and in response to the driver's input at the throttle pedal 100, for example. Therefore, in the third embodiment, the first and second body portions 21, 22 may be moved relative to each other while both are also moving relative to the third and fourth body portions 96, 98.

The bearings 91-93 used in the third embodiment may also act as seals between the body portions 21, 22, 96, 98. Various types of bearings may be implemented in a given embodiment. Also, with the benefit of this disclosure, one of ordinary skill in the art will likely realize other possible types of bearings and/or seals that may be implemented between the body portions that move relative to each other.

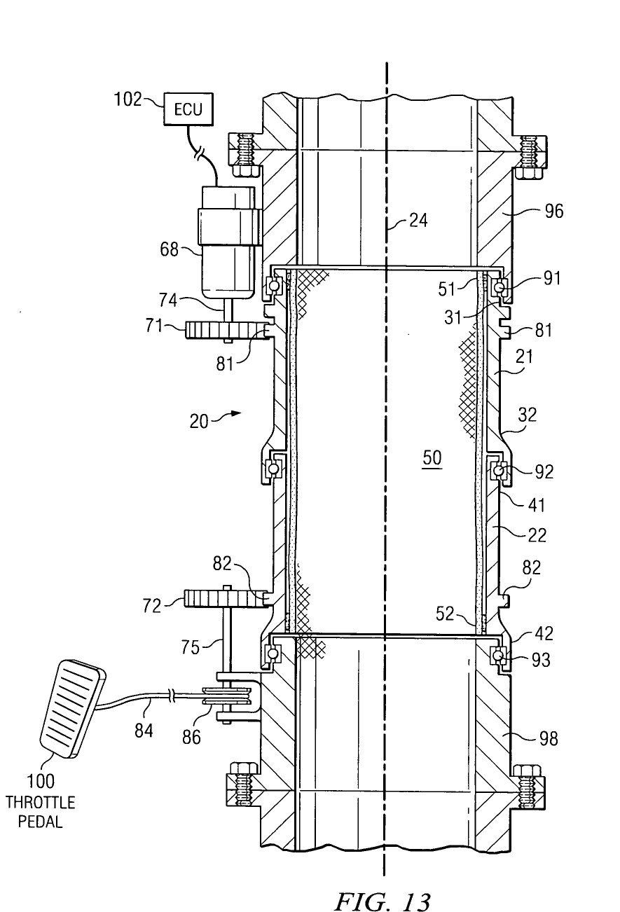

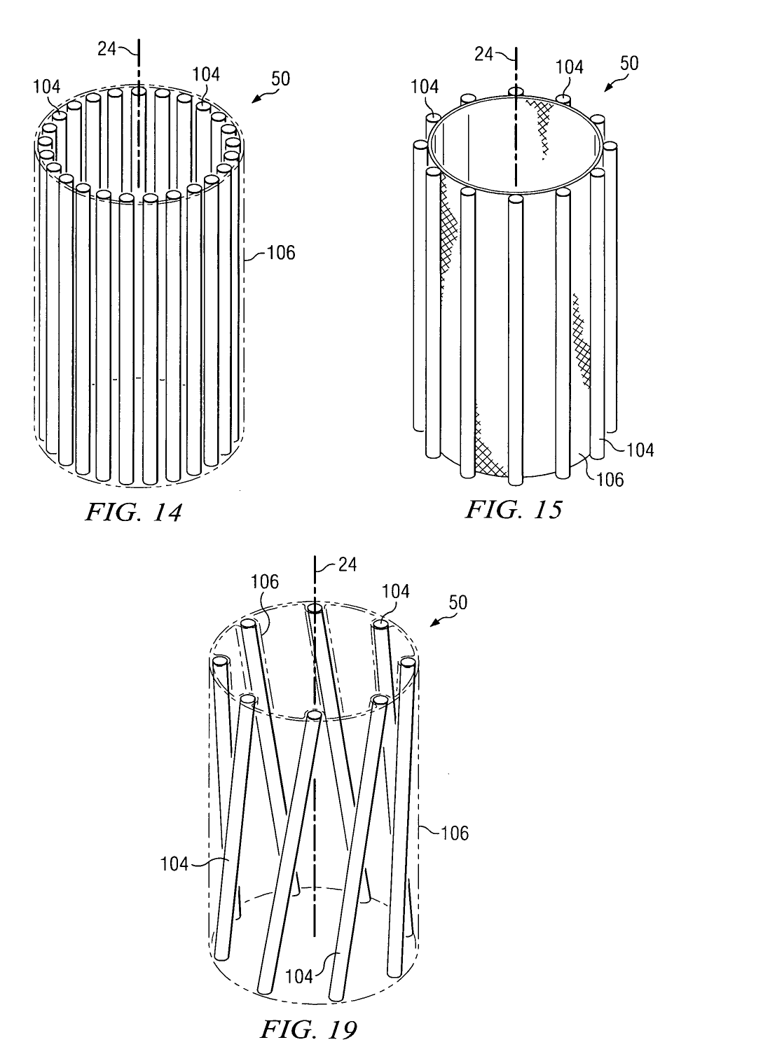

FIGS. 14-19 show ducts 50 for fourth through eighth embodiments of the present invention, respectively. For purposes of simplification and focusing on some duct variations, the body portions of these embodiments are not shown. In FIG. 14, the duct 50 of the fourth embodiment has rods 104 attached to its internal surface. The rods 104 in the fourth embodiment extend generally along and substantially parallel with the longitudinal axis 24 of the duct 50. When the duct 50 is twisted (not shown), the rods 104 will become slanted and will extend diagonally relative to the longitudinal axis 24. The rods 104 may be used to provide support for the flexible duct membrane 106. One possible advantage of the rods 104 in the fourth embodiment is that they may affect flow characteristics a fluid flowing through the duct 50. For example, when the duct 50 is partially twisted, and hence the rods 104 are slanted, the rods 104 may enhance the rifling effect on the flow stream. The rods 104 may be attached to the duct membrane 106 using any of a variety of ways, including (but not necessarily limited to): adhesively bonded, thermally bonded, ultrasonically bonded, chemically bonded, or any combination thereof, for example.

In FIG. 15, the duct 50 of the fifth embodiment has rods 104 attached to its outer surface. The rods 104 of the fifth embodiment may be attached and arranged relative to the longitudinal axis 24 similar to the ways discussed above regarding the fourth embodiment. Also, note that in the fourth through eighth embodiments, the rods 104 may or may not extend along the entire length of the duct 50 along the longitudinal axis 24. Furthermore, the number of rods 104 used and the distribution of the rods 104 about the perimeter of the duct 50 may vary.

FIGS. 16-18 are top views of the ducts 50 for the sixth, seventh, and eighth embodiments. In the sixth, seventh, and eighth embodiments, the rods 104 are embedded within the duct membrane material 106. In the sixth embodiment (FIG. 16), the rods 104 are positioned along the middle of the duct circumference. In the seventh embodiment (FIG. 17), the rods 104 are positioned along the inside of the duct 50 so that the outer duct surface is substantially smooth. And in the eight embodiment (FIG. 18), the rods 104 are positioned along the outside of the duct 50 so that the inner duct surface is substantially smooth.

FIG. 19 is a perspective view of a duct 50 for a ninth embodiment of the present invention. In FIG. 19, the duct membrane portion 106 is shown in dashed lines to better illustrate the configuration of the rods 104. In the ninth embodiment, the rods 104 are embedded in the duct membrane 106 at a slanted angle (e.g., an acute angle) relative to the longitudinal axis 24. Thus, at a fully-open position, as shown in FIG. 19, the rods 104 are still slanted. Hence, the rods 104 may provide a rifling effect on the fluid flow through the duct 50 in all configurations (full-open, half-open, full-closed). When the duct 50 is twisted to be closed, the rods 104 are further slanted relative to the longitudinal axis 24.

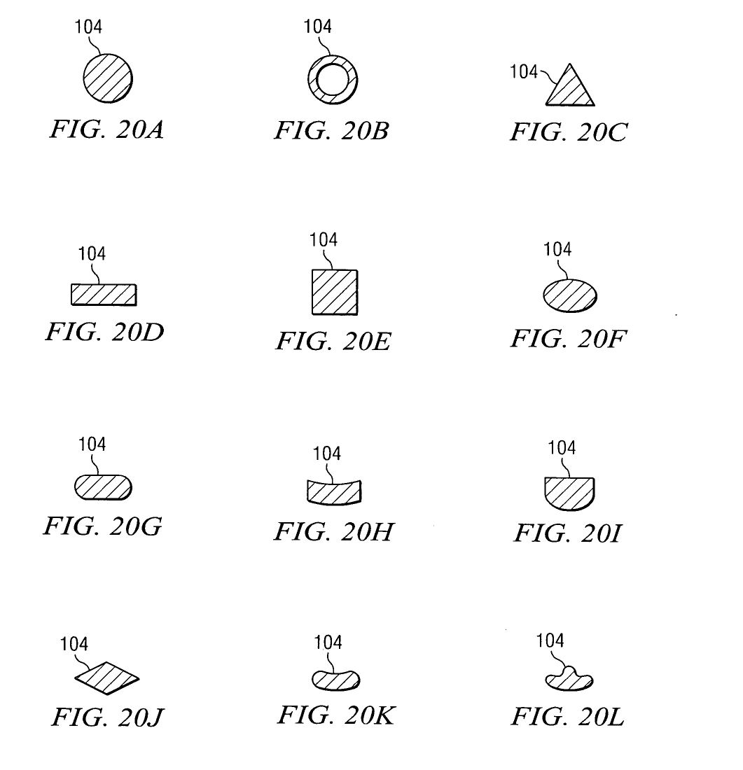

Although the rods 104 shown in the fourth through ninth embodiments (see FIGS. 14-19) have only circular cross-sections, the cross-section shape of any of the rods 104 may be other shapes. FIGS. 20A-20L illustrate some possible rod cross-section shapes that may be used in an embodiment of the present invention, which include: circular, hollow, triangular, rectangular, square, oval, elliptical, rectangular with rounded comers, arc shaped, solid D-shaped, diamond shaped, arc shaped with rounded comers, and arbitrarily shaped, for example. Any of the rods 104 may be solid, hollow, or partially hollow. Also, the cross-section shape and/or size of a rod 104 may vary along the length of the rod 104 or may be constant. Furthermore, a rod 104 may have layers of different or same materials.

An embodiment of the present invention preferably incorporates one or more springs to return the duct 50 to a twisted (partially or fully closed) or untwisted (fully open) configuration when a throttle is not actuated. As will be apparent to one of ordinary skill in the art, the placement of a spring may be at or about the apparatus and/or at the throttle actuation device (e.g., throttle pedal in a car, throttle twist handle on a motorcycle, throttle hand lever on a personal watercraft). In other embodiments, a push-pull throttle cable system may be incorporated to provide direct actuation of the throttle position (i.e., pivoting of the first body portion 21 relative to the second body portion 22) in both directions (with or without also using a spring). In still other embodiments, some other linkage may be used to actuate the position of the first body portion 21 relative to the second body portion 22, including (but not necessarily limited to): lever(s), gear(s), belt(s), cable(s), slider(s), rack/pinion(s), or any combination thereof, for example. Also, in another embodiment, the movement of the first body portion 21 relative to the second body portion 22 to twist and untwist the duct 50 may be partially or completely actuated by: one or more computer controlled motors (e.g., throttle by wire), pneumatic pressure, vacuum pressure, hydraulic pressure, or any combination thereof, for example.

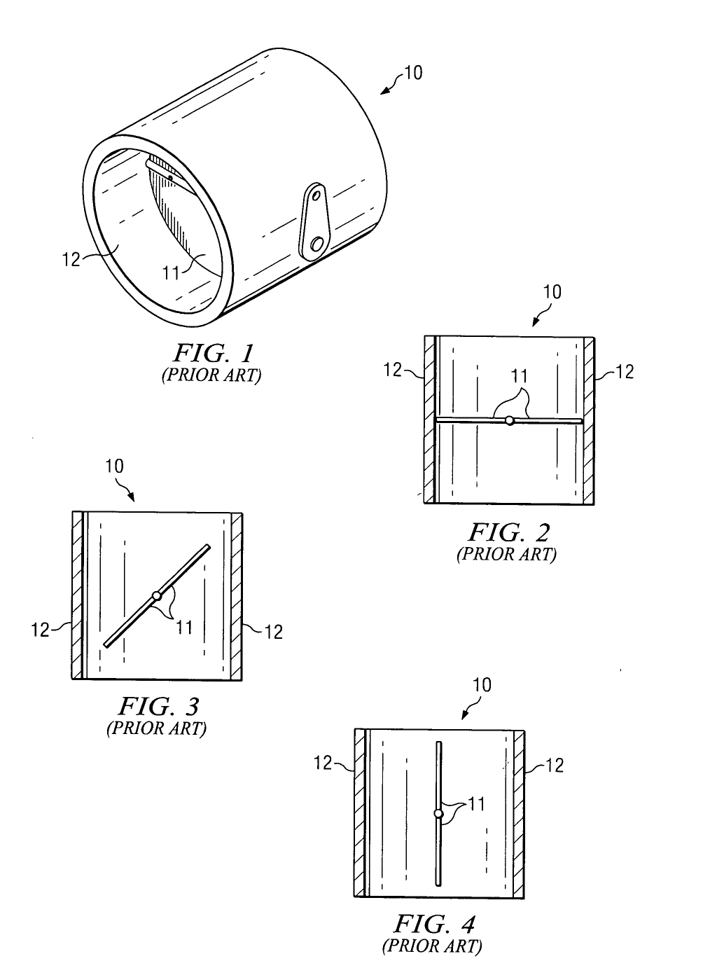

The next series of figures illustrate some example uses of embodiments of the present invention. Although the throttle valve apparatuses 20 of FIGS. 1-13 were shown as separate members (i.e., not connected to anything) for purposes of illustration, a throttle valve apparatus 20 may be an integral part of a port or manifold, or it may be a separate part, which may be fastened to another part or system during normal use.

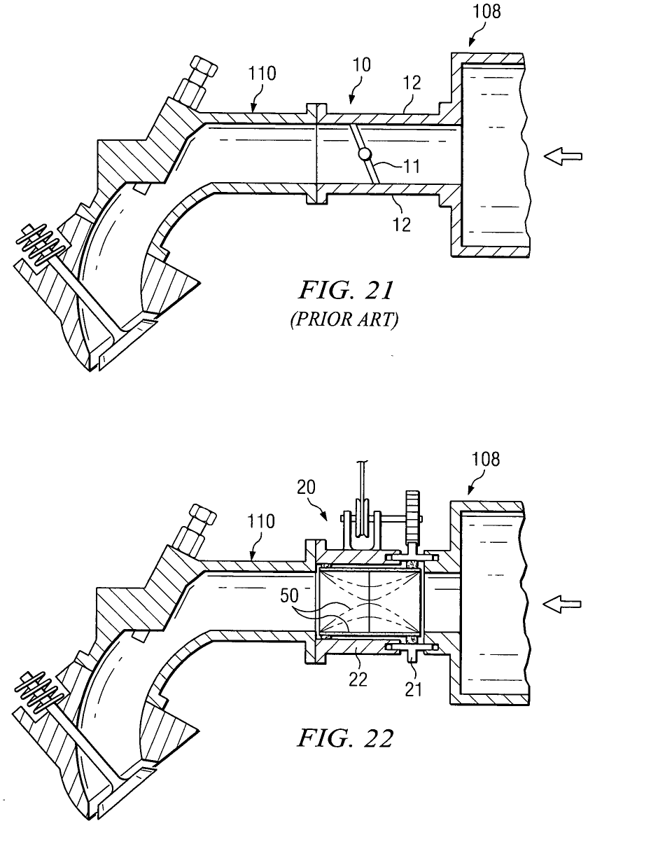

FIG. 21 is a sectional view of a portion of an intake manifold 108 and an intake port 110 on an engine for a 1990 Lotus Esprit SE sports car. A conventional single-blade throttle blade 11 is used in this design. However, FIG. 22 illustrates how an embodiment 20 of the present invention may be incorporated into this engine system in place of the conventional single-blade throttle valve 11. It is expected that with the incorporation of an embodiment 20 of the present invention (as in FIG. 22), the intake port 110 will have a higher flowrate for most partially-open and full-open configurations of the duct, which may increase the performance of the engine. In FIG. 22, the duct 50 is shown in a fully-open configuration. Also in FIG. 22, the duct 50 is shown in phantom lines to represent a partially closed and fully-closed configuration of the duct, for illustration.

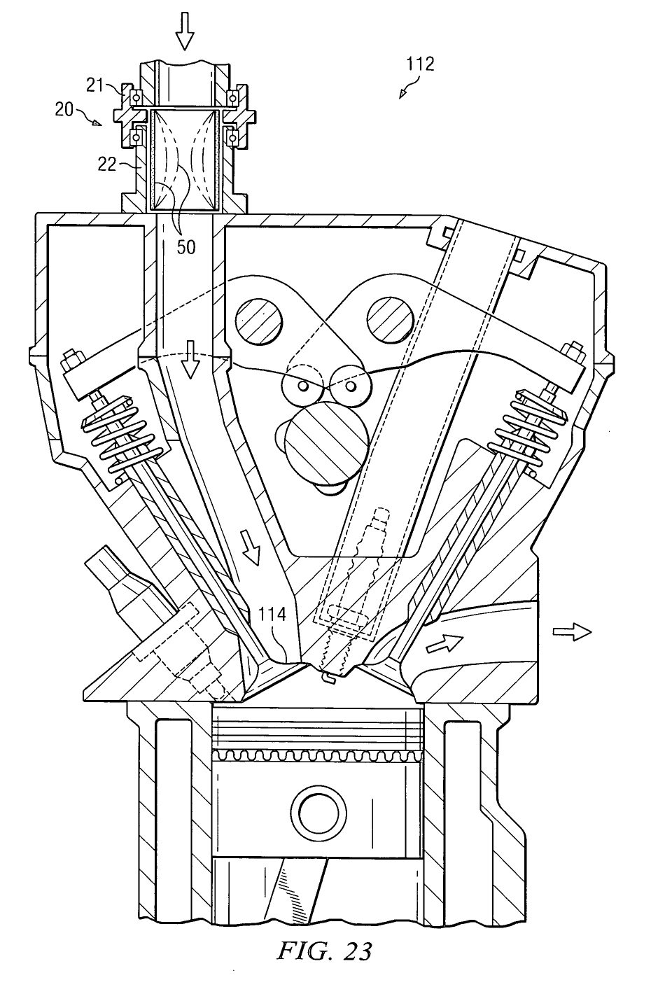

FIG. 23 is a sectional view showing part of a direct gas injection (DGI) engine 112 incorporating an embodiment 20 of the present invention to control the air flow to the intake valve 114. In a DGI engine 112, the fuel is injected directly into the cylinder downstream of the intake valve 114. Hence, in such an embodiment, the duct 50 is less likely to be exposed to fuel. If the duct 50 is not exposed to fuel, then the material used for the duct member may be chosen from a larger variety of possible materials. In FIG. 23, the duct 50 is shown in a fully-open configuration. Also in FIG. 23, the duct 50 is shown in phantom lines to represent a partially closed and fully-closed configuration of the duct, for illustration. In some DGI engine systems, the engine speed and power output is primarily controlled by the fuel flow. Thus in such engine systems, the position of the throttle valve apparatus 20 (i.e., how much the duct 50 is twisted), may not be directly proportional to the gas pedal position. The position of a throttle valve apparatus 20 of an embodiment may be controlled solely by a computer and/or may be controlled independent of the gas pedal position. In an economy mode, for example, a throttle valve apparatus 20 used to control air flow may remain open all the time (e.g., more air and less fuel). Then, in a performance or power mode, the position of the throttle valve apparatus may be varied (e.g., greater fuel to air ratio, more fuel per unit of air). Hence, one of the advantages of an embodiment of the present invention is that the throttle valve apparatus may cause very little or no flow resistance and it may provide a substantially unrestricted passageway when in a fully-open configuration.

Another advantage of an embodiment of the present invention is that a throttle valve apparatus may vary or increase the velocity of air passing therethrough with little effect on the flowrate, as compared to other throttle valve designs (see e.g., FIGS. 1-4). In some applications, it may be desirable to increase the velocity while restricting the flow rate, such as for providing an improved tumbling effect within the cylinder and/or more efficient burn due to increased movement of the air within the cylinder. Still another advantage of an embodiment of the present invention is that a throttle valve apparatus may provide more desirable air flow patterns (e.g., twirling, laminar) coming out of the throttle valve, as compared to other throttle valve designs (see e.g., FIGS. 1-4).

Another application that may benefit from the use of an embodiment of the present invention is an engine system that rarely uses a throttle valve for controlling air intake to control the airflow into the cylinders. One such example is a BMW Valvetronic engine system (not shown) that has computer managed and fully variable intake valves that control the amount of air allowed into the cylinders. This BMW system can vary the intake valve lift from fully closed to fully open. This BMW system incorporates a conventional throttle plate, which is typically only used as a failsafe or for certain diagnostic functions. During normal operation, the throttle plate is held wide open. Hence, incorporating an embodiment of the present invention into such a BMW system, or any other similar system, may be beneficial. Because a throttle valve apparatus in accordance with an embodiment of the present invention may cause very little or no flow resistance and it may provide a substantially unrestricted passageway when in a fully-open configuration, this may be advantageous for use in an engine system, such as the BMW Valvetronic engine system.

FIG. 24 shows a sectional side view for part of a motorcycle engine system 120 from a Ducati model 998 motorcycle. One of the engine heads 122, intake ports 124, and fuel injectors 126 is shown in FIG. 24. This Ducati intake and fuel injection system design shown in FIG. 24 uses a shower-type fuel injector 126 and a conventional single throttle blade 11. In FIG. 24, the throttle blade 11 is shown in a fully-open position. Also in FIG. 24, the throttle blade 11 is shown in half-open and fully-closed positions in phantom lines for illustration. A problem that may arise in using a conventional throttle blade 11, as shown in FIG. 24, is that fuel may accumulate on and drip from the throttle blade 11 because the fuel is being sprayed directly at the throttle blade 11. This may be especially true when the throttle blade 11 is partially open or almost closed, or when transitioning between full throttle and closed throttle, for example.

FIG. 25 illustrates how an embodiment of the present invention may be incorporated into this engine system 120 in place of the conventional single-blade throttle valve 10. It is expected that with the incorporation of an embodiment of the present invention (as in FIG. 25), the intake port 124 will have a higher flowrate for most partially-open and full-open configurations of the duct, which may increase the performance of the engine 120. In FIG. 25, the duct 50 is shown in a fully-open configuration. Also in FIG. 25, the duct 50 is shown in phantom lines to represent a partially closed and fully-closed configuration of the duct, for illustration. Because the shower-type fuel injector configuration directs the fuel toward the center of the intake port 124 and because the restrictive opening of the duct 50 for an embodiment of the present invention is typically at the center of the intake port 124, incorporating an embodiment of the present invention into such an engine system 120 may be quite beneficial.

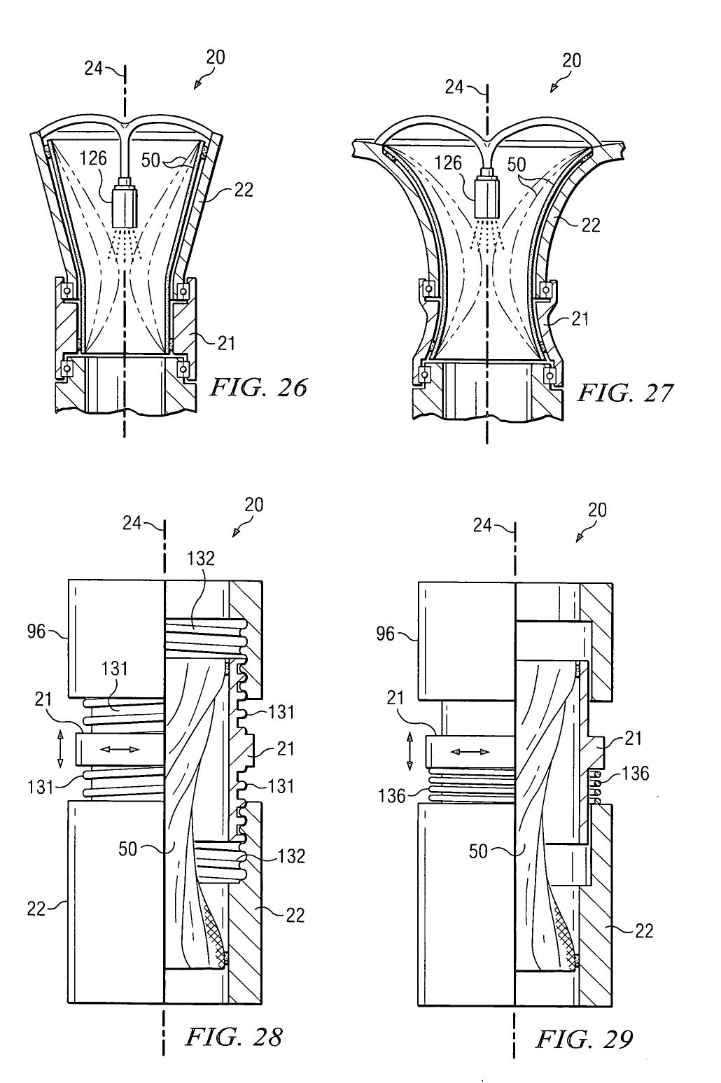

The position of the injector 126 in FIG. 25 may be varied relative to the position of the restrictive opening of the duct 50 along the longitudinal axis 24 for other embodiments (i.e., injector 126 close to the restrictive duct opening or injector 126 further from the restrictive duct opening along the longitudinal axis 24), as shown in FIGS. 26 and 27 for example. Although the body portions 21, 22 are shown as cylindrical in the embodiments herein, as is sometimes preferred, the body portions 21, 22 may have other shapes. For example, the body portions may be frustum or generally conical shaped, as shown in an embodiment in FIG. 26 (see second body portion 22). FIG. 26 is a simplified sectional side view of an embodiment having a frustum-shaped body portion 22. Note in FIG. 26 that the injector 126 may be located within the duct 50. As shown in another embodiment in FIG. 27, the second body portion 22 may be curved outward. In FIG. 27, the injector 126 is located just inside the duct 50. In each of FIGS. 26 and 27, the duct 50 is shown in dashed lines in a half-open and a closed position for purposes of illustration. An advantage of the embodiments shown in FIGS. 26 and 27 may be that the shape of the second body portion 22 allows the injector 126 to be placed closer to the restrictive duct opening location. Another advantage may be allowing the length of the intake port to be shortened, if desired for a given engine design.

In an embodiment having a fuel injector 126 upstream of the duct 50, such as those shown in FIGS. 25-27, it is preferable to use a duct membrane material capable of being exposed to fuel (or perhaps even squirted with fuel). One of ordinary skill in the art will likely realize many possible materials that may be exposed to fuel without significantly degrading the material. However, it may be necessary to replace the duct membrane periodically to ensure optimal performance. For this reason, the duct 50 may be removable for replacement in some embodiments.

Although the embodiments described above have incorporated a duct 50 made from a material that is both pliable and stretchable (e.g., elastic material). However, an embodiment of the present invention may incorporate a duct 50 made from a material that is pliable, but has little or no ability to stretch. In other words, some materials may not have the ability to stretch enough to allow the duct to twist while keeping the first and second body portions 21, 22 at fixed positions along the longitudinal axis 24. FIGS. 28 and 29 illustrate tenth and eleventh embodiments of the present invention that incorporate a substantially non-stretchable duct 50. When a “non-stretchable” duct is twisted, its overall length will tend to be shortened along the axis of twisting (e.g., longitudinal axis). Hence to compensate for shortening during twisting, at least one of the body portions (e.g., first body portion 21) is adapted to move along the longitudinal axis 24 while rotating to twist or untwist the duct 50.

In the tenth embodiment shown in FIG. 28, a first body portion 21 has male threaded portions 131. A second body portion 22 and a third body portion 96, each has a female threaded portion 132 corresponding to the male threaded portions 131 of the first body portion 21. As the first body portion 21 is pivoted about the longitudinal axis 24, the first body portion 21 pivots relative to the second and third body portions 22, 96, and the first body portion 21 moves linearly along the longitudinal axis 24 (relative to the second and third body portions 22, 96) according to the pitch of the threaded portions 131, 132. Preferably, the pitch of the threaded portions 131, 132 provides linear movement of the first body portion 21 (relative to the second body portion 22) along the longitudinal axis 24 at a rate per revolution corresponding to the rate of shortening of the duct 50 due to twisting the duct 50. The pitch of the threaded portions 131 and/or 132 may vary along the longitudinal axis 24 or may be constant. The duct 50 is shown in FIG. 28 in a partially twisted (i.e., partially closed) configuration.

In the eleventh embodiment shown in FIG. 29, a first body portion 21 is adapted to slide within a second body portion 22 and a third body portion 96. A spring 136 may be used to bias the first body portion 21 toward the third body portion 96 to keep tension on the duct 50 along the longitudinal axis 24 (i.e., to keep the duct 50 extended). As the duct 50 is twisted (i.e., when the first body portion 21 is pivoted relative to the second body portion 22), the shortening of the duct 50 along the longitudinal axis 24 due to twisting compresses the spring 136 and the first body portion 21 moves linearly along the axis 24 toward the second body portion 22. With the benefit of this disclosure, one of ordinary skill in the art will likely realize other variations, configurations, and embodiments where a first body portion 21 may move linearly along the longitudinal axis 24 relative to the second body portion 22 to compensate for shortening of the duct 50 due to twisting the duct 50 (and lengthening of the duct 50 due to untwisting the duct 50). The duct 50 is shown in FIG. 29 in a partially twisted (i.e., partially closed) configuration.

Although the first body portion 21 is immediately adjacent the second body portion 22 in the embodiments shown in FIGS. 5-13, 22, 23, and 25-29, in other embodiments or in variations of the above-described embodiments, this may not be the case. Hence in other embodiments or in variations of the above-described embodiments, even though the first body portion 21 is generally adjacent the second body portion 22, there may be one or more intermediate body portions located between the first body portion 21 and the second body portion 22.

For example, FIG. 30 is a sectional side view of a twelfth embodiment of the present invention. In the twelfth embodiment, an intermediate body portion 150 is located between the first body portion 21 and the second body portion 22. Hence, in the twelfth embodiment shown in FIG. 30, the duct 50 extends through the intermediate body portion 150. The intermediate body portion 150 may be fixed while the first and second body portions 21, 22 may be permitted to pivot about the longitudinal axis 24, for example.

FIG. 31 is a plot 160 showing the results of a test performed by the inventor. In this test, the tested embodiment was the throttle valve apparatus 20 of the first embodiment shown in FIG. 7 having a duct like that shown in FIG. 14 (i.e., a variation of the fourth embodiment). The tested embodiment was compared to a conventional throttle valve apparatus design, as shown in FIGS. 1-4 as throttle valve apparatus 10. For the comparison test, the throttle bodies 12, 21, 22 of the tested embodiment and the conventional single-blade design were made from the same material (PVC pipe) and had the same diameters (1.75 inch inside diameter). First, the throttle valve apparatus 10 of the conventional single-blade design was tested on a flow bench at pressure of about 21.3 inches of water (about 0.8 psi). The volumetric flow rate through the conventional throttle valve apparatus 10 was measured at one-quarter-open, half-open (as shown in FIG. 3), three-quarter-open, and full-open (as shown in FIG. 4) blade positions for the throttle blade 11, which resulted in flow rate measurements of 27 cubic feet per minute (CFM), 78 CFM, 168 CFM, and 235 CFM respectively (see FIG. 31). Then, the throttle valve apparatus 20 of the tested embodiment was fastened to the flow bench in an identical manner and tested under identical conditions. At one-quarter-open, half-open, three-quarter-open, and full-open (completely untwisted) positions, the volumetric flow rate measurements were 38 CFM, 123 CFM, 204 CFM, and 242 CFM, respectively (see FIG. 31). Thus, the tested embodiment of the present invention provided a 41% increase in volumetric flow rate at the one-quarter-open throttle position, a 58% increase in flow rate at the half-open throttle position, a 21% increase in flow rate at the three-quarter-open throttle position, and a 3% increase in flow rate at the full-open throttle position. But, note that the tested embodiment was a prototype that was not refined to mass production specifications (i.e., it had some rough edges and duct tape), which likely had some negative effects upon the test results. Hence, even better increases are likely to be achieved with refined fabrications of the tested embodiment, incorporating appropriate materials, and/or use of other embodiments of the present invention. Also, a characteristic not measured or studied in this test was the type or pattern of flow (e.g., turbulent, laminar, mixed, twirling) exiting the throttle valve apparatus. For example, the rods of the tested embodiment may provide a twirling or rifling effect on the fluid exiting the throttle valve apparatus (e.g., at partially-closed throttle positions), which may be desirable for some applications.

Some applications use a throttle valve (i.e., a butterfly valve, as in FIGS. 1-4) in the exhaust flow to vary the back pressure. An embodiment of the present invention may be used in such applications to provide a controlled change in exhaust back pressure. An advantage of an embodiment of the present invention, as compared to prior throttle valve designs, is that it may provide the desired changes in back pressure but with less restriction on flow rate, with a more desirable exiting flow pattern, and/or with an increased air velocity. Another application may use an embodiment of the present invention as a waste gate valve for a turbocharger system. Yet another application may use an embodiment of the present invention before and/or after a turbocharger to control or change flow into and/or out of the turbocharger, for example. In such applications, the throttle valve apparatus may be controlled by a computer and/or in response to an actuation of a foot pedal or other driver controlled lever or switch, for example.

Also, two or more throttle valve apparatus embodiments may be used in series and/or in parallel in various places in an engine system. Because the control of air flow into and out of and through various parts of an engine system is becoming more of a concern with current and future engine systems, with the benefits of this disclosure, one of ordinary skill in the art will likely realize many other uses for an embodiment of the present invention beyond the illustrative examples discussed and/or shown herein.

Although many of the applications and embodiments of the present invention discussed thus far have focused on engine applications, an embodiment of the present invention may have many other possible applications, including but not limited to: any machine with an internal combustion engine; steam turbines; gas turbines; jet engines; liquid plumbing; a manufacturing process machine having a portion for controlling fluid flow (e.g., steam flow, vapor flow, gas flow); and heating, ventilation, and air conditioning (HVAC) systems, for example. Motorized vehicle applications may include, but are not limited to: motorcycles, snowmobiles, cars, trucks, tractors, boats, personal watercrafts, trains, airplanes, helicopters, tanks, or submarines, for example. The term “fluid,” as used herein, is used in its broadest sense, including: air, air-fuel mixtures, gas, liquid, gas-liquid mixtures, suspended solid particles, vapor, steam, or any combination thereof.

Although embodiments of the present invention and at least some of its advantages en described in detail, it should be understood that various changes, substitutions, and alterations can be made herein without departing from the spirit and scope of the invention as by the appended claims. Moreover, the scope of the present application is not intended to be limited to the particular embodiments of the process, machine, manufacture, composition of means, methods, and steps described in the specification. As one of ordinary skill in the readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such process, machines, manufacture, compositions of matter, means, methods, or steps.

1. An apparatus for controlling fluid flow, comprising:
a first hollow body portion extending along a longitudinal axis of the apparatus;
a second hollow body portion extending along the longitudinal axis; and
an internal duct extending along the longitudinal axis, the duct being formed from a pliable membrane, the duct being attached to the first body portion at a first duct location, and the duct being attached to the second body portion at a second duct location, wherein the first body portion and the first duct location are adapted to pivot about the longitudinal axis relative to the second body portion and the second duct location for twisting and untwisting the duct.

2. The apparatus of claim 1, wherein the first body portion is adjacent the second body portion along the longitudinal axis.

3. The apparatus of claim 1, further comprising an intermediate body portion located between the first body portion and the second body portion along the longitudinal axis.

4. The apparatus of claim 1, at least part of the duct being located in at least part of the first and second body portions.

5. The apparatus of claim 1, wherein the first body portion has a generally cylindrically-shaped tubular interior surface, and wherein the second body portion has a generally cylindrically-shaped tubular interior surface

6. The apparatus of claim 1, further comprising a bearing, wherein the first body portion is pivotably attached to the second body portion via the bearing.

7. The apparatus of claim 1, further comprising a rod being in contact with the duct and extending generally along the longitudinal axis.

8. The apparatus of claim 7, wherein the rod is substantially parallel with the longitudinal axis when the duct is in a fully open position, and such that the rod is slanted at an acute angle relative to the longitudinal axis when the duct is at least partially twisted.

9. The apparatus of claim 7, wherein the rod is slanted at an acute angle relative to the longitudinal axis when the duct is in a fully open position.

10. The apparatus of claim 7, further comprising additional rods, the additional rods being distributed about the circumference of the duct and extending generally along the longitudinal axis.

11. The apparatus of claim 7, wherein at least part of the rod is flexible.

12. The apparatus of claim 7, wherein at least part of the rod is rigid.

13. The apparatus of claim 7, wherein at least part of the rod has a cross-sectional shape selected from a group consisting of circular, elliptical, oval, rectangular, square, triangular, rectangular with rounded comers, rounded, curved, and arbitrarily shaped.

14. The apparatus of claim 7, wherein the rod is embedded in the membrane of the duct.

15. The apparatus of claim 7, wherein at least part of the rod is affixed to the membrane of the duct.

16. The apparatus of claim 15, wherein the rod is attached to an exterior surface of the duct.

17. The apparatus of claim 15, wherein the rod is attached to an interior surface of the duct.

18. The apparatus of claim 1, further comprising a spring biased upon the first body portion.

19. The apparatus of claim 1, further comprising a spring biased upon the second body portion.

20. The apparatus of claim 1, further comprising:
a gear portion extending from an exterior of the first body portion.

21. An apparatus for controlling fluid flow, comprising:
a first hollow body portion extending along a longitudinal axis of the apparatus;
a second hollow body portion extending along the longitudinal axis;
an internal duct extending along the longitudinal axis, the duct being formed from a pliable membrane, the duct being attached to the first body portion at a first duct location, and the duct being attached to the second body portion at a second duct location, wherein the first body portion and the first duct location are adapted to pivot about the longitudinal axis relative to the second body portion and the second duct location for twisting and untwisting the duct; and
a rod being in contact with the duct and extending generally along the longitudinal axis.

22. The apparatus of claim 21, wherein the rod is substantially parallel with the longitudinal axis when the duct is in a fully open position, and such that the rod is slanted at an acute angle relative to the longitudinal axis when the duct is at least partially twisted.

23. The apparatus of claim 21, wherein the rod is slanted at an acute angle relative to the longitudinal axis when the duct is in a fully open position.

24. The apparatus of claim 21, further comprising additional rods, the additional rods being distributed about the circumference of the duct and extending generally along the longitudinal axis.

25. The apparatus of claim 21, wherein at least part of the rod is flexible.

26. The apparatus of claim 21, wherein at least part of the rod is rigid.

27. The apparatus of claim 21, wherein at least part of the rod has a cross-sectional shape selected from a group consisting of circular, elliptical, oval, rectangular, square, triangular, rectangular with rounded comers, rounded, curved, and arbitrarily shaped.

28. The apparatus of claim 21, wherein the rod is embedded in the membrane of the duct.

29. The apparatus of claim 21, wherein at least part of the rod is affixed to the membrane of the duct.

30. An apparatus for controlling fluid flow, comprising:
a first hollow body portion extending along a longitudinal axis of the apparatus;
a second hollow body portion extending along the longitudinal axis, wherein the second body portion is adjacent to the first body portion along the longitudinal axis; and
an internal duct extending along the longitudinal axis, the duct being formed from a pliable membrane, at least part of the duct being located in at least part of the first and second body portions, the duct having a first duct end attached to the first body portion, and the duct having a second duct end attached to the second body portion, wherein the first body portion and the first duct end are adapted to pivot about the longitudinal axis relative to the second body portion and the second duct end for twisting and untwisting the duct.

31. A method of controlling fluid flow, comprising:
providing an apparatus comprising
a first hollow body portion extending along a longitudinal axis of the apparatus,
a second hollow body portion extending along the longitudinal axis, and
an internal duct extending along the longitudinal axis, the duct being formed from a pliable membrane, the duct being attached to the first body portion at a first duct location, and the duct being attached to the second body portion at a second duct location;
allowing fluid to flow at a first flow rate through the apparatus via the duct when the duct is untwisted; and
restricting fluid flow through the duct to a second flow rate when the duct is at least partially twisted, wherein the second flow rate is less than the first flow rate.

32. The apparatus of claim 31, wherein the apparatus further comprises a rod that is in contact with the duct and extends generally along the longitudinal axis, and further comprising:
supporting the duct with the rod.

33. An engine system comprising:
an apparatus for controlling fluid flow, the apparatus comprising
a first hollow body portion extending along a longitudinal axis of the apparatus;
a second hollow body portion extending along the longitudinal axis; and
an internal duct extending along the longitudinal axis, the duct being formed from a pliable membrane, the duct being attached to the first body portion at a first duct location, and the duct being attached to the second body portion at a second duct location, wherein the first body portion and the first duct location are adapted to pivot about the longitudinal axis relative to the second body portion and the second duct location for twisting and untwisting the duct.
